(19) United States
(12) Patent Application Publication
(10) Pub. No.: US 2013/0347035 A1
(43) Pub. Date: Dec. 26, 2013

(54) SYSTEMS AND METHODS FOR NAVIGATING TO A FAVORITE CONTENT SOURCE WITHOUT AN ADVERTISEMENT

(71) Applicants: Young Tang, Burbank, CA (US); Steve Conard, Saugus, CA (US); Helen Zhang, Burbank, CA (US); Brian C. Peterson, Barrington, IL (US); Paul T. Stathacopoulos, San Carlos, CA (US)

(72) Inventors: Young Tang, Burbank, CA (US); Steve Conard, Saugus, CA (US); Helen Zhang, Burbank, CA (US); Brian C. Peterson, Barrington, IL (US); Sreeram Krishna, San Jose, CA (US); Paul T. Stathacopoulos, San Carlos, CA (US)

(73) Assignee: UNITED VIDEO PROPERTIES, INC., Santa Clara, CA (US)

(21) Appl. No.: 13/529,478

(22) Filed: Jun. 21, 2012

(51) Int. Cl. H04N 21/482

(52) U.S. Cl. CPC H04N 21/482
USPC 725/38

(57) ABSTRACT

Systems and methods are provided for displaying media assets on user equipment. One of several content sources is designated as a first favorite content source. A first media asset that the user desires to view is displayed on a display screen of the user equipment. It is determined whether the first content source includes an advertisement. Upon determining that a first content source that provides the first media asset includes an advertisement, the first favorite content source is automatically accessed.

### BACKGROUND

Traditional media guidance applications provide media content from a content provider along with advertisements. A user that desires to navigate to another media asset during a commercial break may encounter another media asset that is also in a commercial break. Traditional media content applications fail to consider whether another media content includes an advertisement when navigating the user between media content.

### SUMMARY

In view of the foregoing, methods and systems for providing media content for displaying media assets are provided. The systems and methods described below include techniques for displaying media assets implemented on user equipment with a display screen and a user input interface.

In several embodiments of the present invention, a content characteristic of a media asset originally displayed on the display screen of the user equipment is identified. In some implementations, content characteristic may be a genre associated with the media asset. A request to change the media asset being displayed on the display screen may be received at the user equipment. In response to receiving such a request, a search is performed to find another media asset that matches the identified content characteristic of the originally displayed media asset. In addition, it is also determined whether the content source of the newly found media asset includes an advertisement at the time of the request. If a media asset satisfies both of these criteria, the identified media asset is displayed on the display screen.

In some embodiments, the content source of the originally displayed media asset is monitored to detect whether the content source still includes an advertisement. In an implementation, a message is displayed on the display screen when the originally displayed media asset's content source no longer includes an advertisement. In another implementation, a visual indicator is displayed on the display screen when the originally displayed media asset's content source no longer includes an advertisement. The originally displayed media asset is accessed either automatically or in response to user input once it is determined that the originally displayed media asset's content source no longer includes an advertisement. The originally displayed media asset may be paused if the originally displayed media asset is not being displayed and the originally displayed media asset's content source no longer includes an advertisement.

In some embodiments, if a media asset is found that matches the originally displayed media asset's content characteristic but its content source includes an advertisement at the time of the request, then a search for another media asset is performed. The search for a different media asset will be conducted until such a media asset is found that both matches the content characteristic of the originally displayed media asset and for which the media source of the media asset does not provide an advertisement at the time of receipt of the request to change the media asset being displayed.

In some embodiments, a favorite content source may be searched if the originally displayed media asset's content source includes an advertisement.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIG. 1 shows an illustrative display screen that may be used to provide media guidance application listings and other media guidance information in accordance with various embodiments of the invention;

FIG. 2 shows another illustrative display screen that may be used to provide media guidance application listings in accordance with various embodiments of the invention;

FIG. 3 shows a block diagram of an illustrative user equipment device in accordance with various embodiments of the invention;

FIG. 4 shows a block diagram of an illustrative interactive media system in accordance with various embodiments of the invention;

FIG. 5 shows a simplified block diagram of an interactive media system interacting with several media content sources in accordance with various embodiments of the invention;

FIG. 6 shows an illustrative display screen displayed when the media content source that the user is accessing displays an advertisement in accordance with several embodiments of the invention;

FIG. 7 shows another illustrative display screen displayed when the media content source the user is accessing, displays an advertisement in accordance with several embodiments of the invention;

FIG. 8 shows an illustrative display screen when the system accesses another content source that does not include an advertisement in accordance with an embodiment of the invention;

FIG. 9 shows an illustrative display screen when the advertisement in the originally accessed media asset ends according to an embodiment of the invention;

FIG. 10 shows an illustrative flow diagram depicting an exemplary process for changing the media asset displayed when an advertisement is detected in the displayed media asset in accordance with several embodiments of the invention;

FIG. 11 shows an illustrative flow diagram depicting an exemplary process for displaying media listings from several content sources in accordance with an embodiment of the invention;

FIG. 12 shows an illustrative flow diagram depicting an exemplary process for switching the display of the media asset upon determining that the originally displayed media asset no longer contains an advertisement in accordance with several embodiments of the invention; and

FIG. 13 shows an illustrative flow diagram depicting an exemplary process for switching the display of the media asset to a favorite content source upon determining that the originally displayed media asset contains an advertisement in accordance with several embodiments of the invention.

### DETAILED DESCRIPTION OF EMBODIMENTS

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

A user may be watching a media asset provided by a media guidance application on a display screen. While a user is watching the media asset, an advertisement may be displayed on the display screen. The user may wish to view a different media asset in order to avoid the advertisement. Additionally, the user may request to view a different media asset that is related to original media asset being watched. Upon receiving a request to change the displayed media asset, the media guidance application proceeds to search for a different media asset which matches the content characteristics of the originally displayed media asset and which is received from a content source that does not provide an advertisement at the time of the user request. Alternatively, the media asset may be switched without any user input upon determining that an advertisement is being displayed at a given time. By searching for a media asset that matches these criteria, the media guidance application provides an easy and efficient solution for the user to watch media assets without advertisements. The user avoids having to manually switch to media assets without any knowledge of whether the content source of that media asset is currently displaying an advertisement.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content. As referred to herein, the term “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

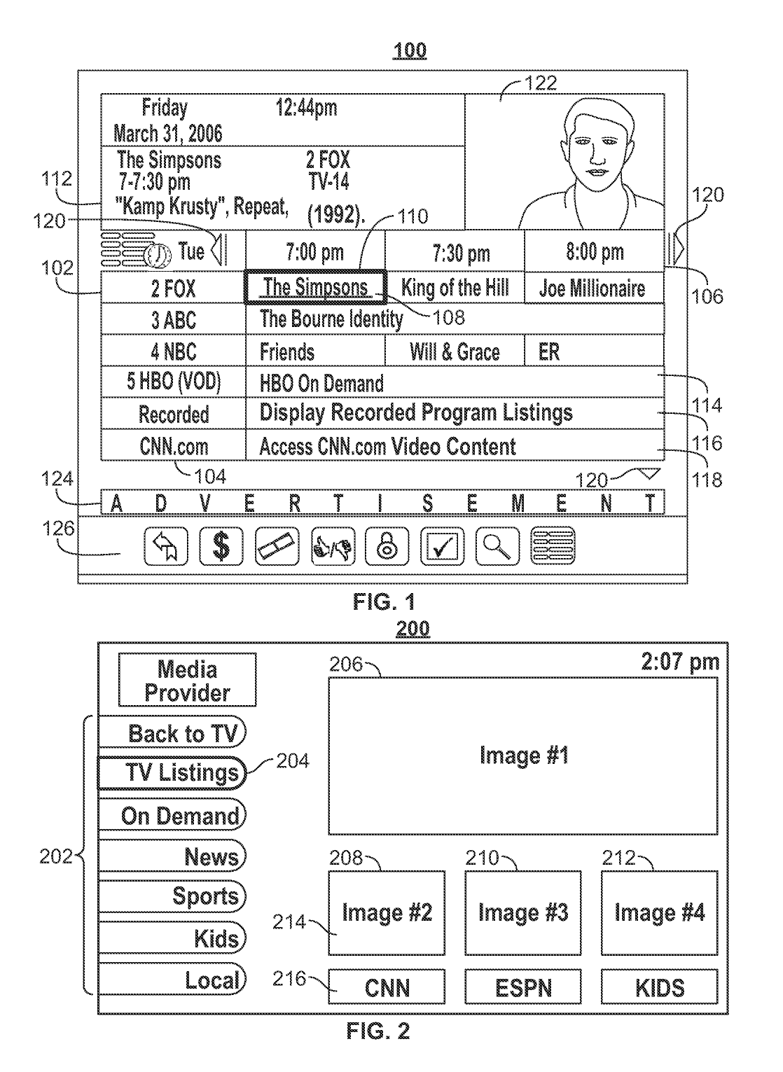

FIGS. 1-2 show illustrative display screens that may be used to provide media guidance data. The display screens shown in FIGS. 1-2 and 6-9 may be implemented on any suitable user equipment device or platform. While the displays of FIGS. 1-2 and 6-9 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features.

Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

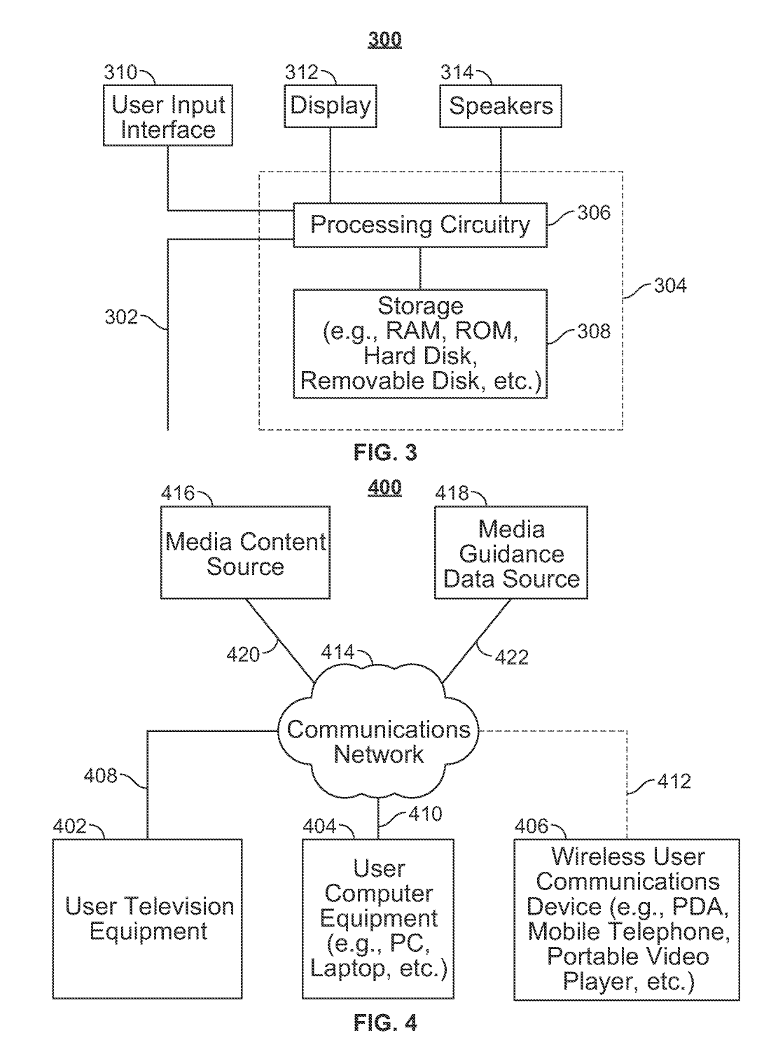

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the ABC, INC., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or, a user device can download content from multiple cloud resources for more efficient downloading. In some embodiments, user equipment devices can use cloud resources for processing operations such as the processing operations performed by processing circuitry described in relation to FIG. 3.

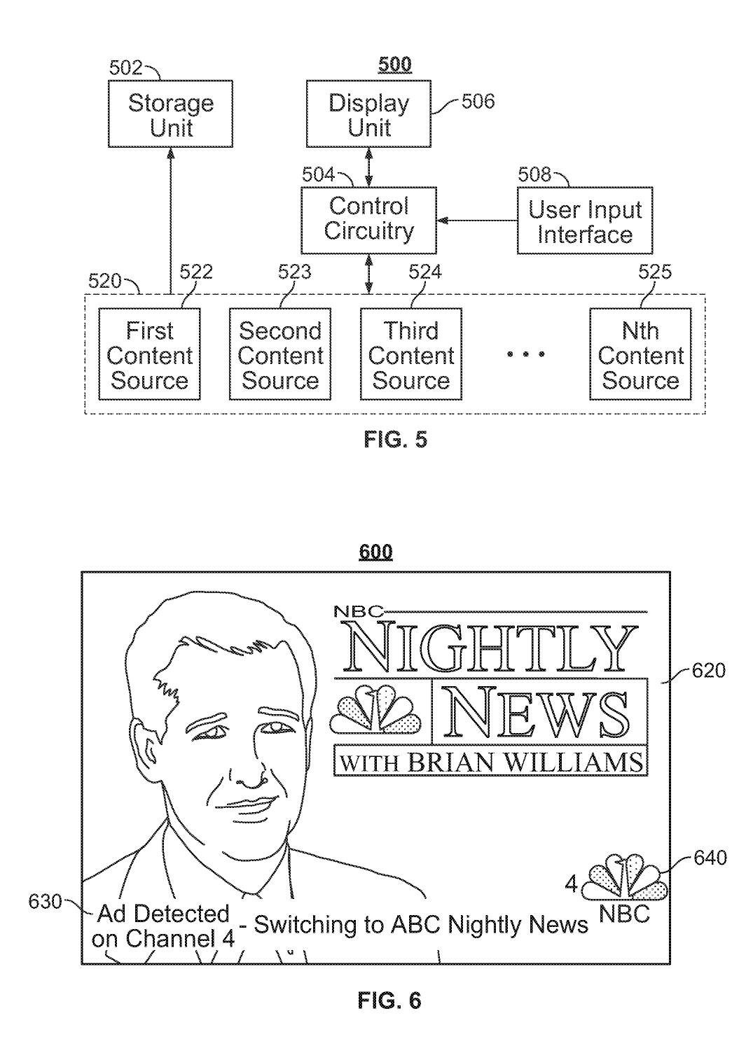

FIG. 5 shows a specific implementation of user equipment device 300 of FIG. 3 interacting with multiple content sources. Control circuitry 504, storage unit 502, display unit 506, and user input interface 508 correspond to control circuitry 304, storage 308, display 312, and user input interface 310 of FIG. 3, respectively. Content sources 522-525 each correspond to a different media content source 416 of FIG. 4. Control circuitry 504 executes the media guidance application in accordance with the embodiments described below. Control circuitry 504 may monitor N amount of content sources, represented as content sources 522-525 in FIG. 5. Control circuitry 504 may retrieve media assets from each of the N content sources 522-525 and store them in storage unit 502. In another implementation, control circuitry 504 may retrieve media assets from each of the N content sources 522-525 and display them on display unit 506 without storing them in storage 502. In yet another implementation, control circuitry 504 may retrieve media assets from each of the N content sources 522-525 and display them on display unit 506 as well as store them in storage 502.

Media assets in each of these N content sources may be associated with multiple types of content characteristics. Genre, cast information, media asset duration, user rating are only a few of these types of content characteristics associated with media assets. In some embodiments, control circuitry 504 may identify a content characteristic from these multiple content characteristics associated with the media asset based on which the content sources will be searched.

In another embodiment, the user may be provided an option to select a content characteristic from a list of content characteristics. Control circuitry 504 will search the content sources for media assets that are associated with the selected content characteristic that match the media asset displayed on display 506 at a specific time, 5 PM for example. Genre will be used as the selected content characteristic for the sake of simplicity in the remaining examples. However, any content characteristic associated with the media asset being displayed on display 506 at 5 PM may be used.

The content characteristic of each media asset may be stored in a data structure corresponding to the content source. Such a data structure may be content source information that is found in the media guidance application data stored in storage 502. The data structure may contain a field that includes the genre information. Accordingly, when control circuitry 504 queries the content characteristic of a particular content source's media assets, control circuitry 504 processes the fields of such data structures for the content source to search for information identifying the content characteristic of the content source's media assets. When control circuitry 504 determines that there is a match between the first media asset's genre and the genre information found in the fields of a content source's data field, control circuitry 504 flags that content source as one that contains a media asset matching the genre of the first media asset.

Each of the content sources 522-525 may contain advertisements at certain time intervals in addition to media assets. Advertisements may be displayed simultaneously with media assets or they may be displayed as full screen displays at separate time intervals from when media assets are displayed.

In addition to determining that the genre of a given media asset matches that of the first media asset, control circuitry 504 also searches the content source information of content sources for advertisement related information. Control circuitry 504 may detect whether a particular content source contains an advertisement by processing the content source's associated content source information. When an advertisement is included in the content source, data structures in the corresponding content source information may contain information indicative of an advertisement. By searching these data structures for information indicating an advertisement, control circuitry 504 determines that the content source includes an advertisement. For example, control circuitry 504 may examine the data feed of a given content source to determine whether the data feed includes closed caption information for content included in the content source at a given time. Since closed captioning is provided when a media asset is transmitted but not when an advertisement is transmitted, control circuitry 504 can determine when an advertisement is present by searching for a break or a lack of closed caption information. For example, control circuitry 504 determines whether the data feed for a content source contains closed caption information at a given time. If control circuitry 504 determines that there is no closed caption information in the data feed of a content source at a given time, then control circuitry 504 determines that the content source is displaying an advertisement at the given time. Conversely, if control circuitry 504 determines that the data feed of the content source includes closed caption information at a given time, control circuitry determines that content source does not provide an advertisement at the given time.

In some embodiments, control circuitry 504 displays a media asset, hereinafter referred to as the first media asset, on display 506 at 5 PM. As a result of determining that the first media asset is displayed on display 506, control circuitry 504 searches media guidance application data, specifically the content source information data structures for various content sources, to determine which other media assets match the content characteristic of the first media asset. In accordance with this embodiment, control circuitry 504 monitors content source information for each of the N content sources to determine which content source contains a media asset with the same genre as the media asset displayed on display 506 at 5 PM. Control circuitry 504 may search metadata or a content feed of each of the content sources to determine the genre of the content sources' media assets.

Control circuitry 504 may be configured to detect from which content source the first media asset is being currently displayed by display 506, hereinafter referred to as the first content source. When control circuitry 504 determines that the first content source includes an advertisement, control circuitry 504 examines content source information of the already identified media assets that match the first media asset's genre for advertisement related information. Since the identification of content sources that contain matching genre media assets has already been performed as soon as the first media asset was displayed on display 506, control circuitry 504 already has identified media assets that match the genre of the first media asset. Once control circuitry 504 determines that an advertisement is included in the first content source, control circuitry 504 only needs to search content source information of the identified content sources for advertisement related information.

When control circuitry 504 detects that the first content source displays an advertisement, control circuitry 504 monitors media guidance application data to determine which of the N content sources to access next.

Once control circuitry 504 identifies the content source that contains a media asset with a genre matching the first media asset at 5 PM, control circuitry 504 processes the content source information of the identified content source. The content source information of the identified media asset is processed to identify data that is indicative of an advertisement being provided at the content source at 5 PM. In some embodiments, if control circuitry 504 determines that the identified content source does not contain an advertisement as result of processing the identified media asset's content source information, then control circuitry 504 retrieves the identified media asset at the user equipment device from the respective content source. If control circuitry 504 determines that the identified content source contains an advertisement, the content source information for the next content source that includes a media asset with a genre matching the first media asset is checked for advertisements at 5 PM. Control circuitry 504 steps through each of the identified content sources until a content source that provides a media asset without an advertisement is identified.

In another embodiment, control circuitry 504 may search through content source information for all of the N content sources and determine that there does not exist a single media asset that satisfies both the criteria of matching content characteristic as the first media asset and being provided on a content source that does not provide an advertisement at the time of the switch. In response to making such a determination, control circuitry 504 may query other appropriate sources besides media guidance application data such as web sites over the Internet the user accesses, such as www.allrovi.com, other media guidance applications the user accesses, other interactive applications the user accesses, or another user equipment device of the user, etc.). Control circuitry 504 may query these external content sources in order to better provide the user with content that does not contain advertisements and that matches the first media asset's content characteristic.

In some embodiments, control circuitry 504 receives a request to change the first media asset displayed on display 506. Such a request may be received from the user through user input interface 508 or generated by control circuitry 504. As a result of determining that a request to change the media asset has been received, control circuitry 504 searches media guidance application data stored in storage 502, specifically content source information for the various content sources, to determine which other media assets match the content characteristic of the first media asset. In accordance with this embodiment, control circuitry 504 monitors content source information for each of the N content sources to determine which content source contains a media asset with the same genre as the media asset displayed on display 506 at 5 PM. Control circuitry 504 may search the metadata or a content feed of each of the content sources to determine the genre of the sources' media assets.

In order to minimize computing operations, control circuitry 304 may only monitor the first content source. When control circuitry 504 detects that the first content source displays an advertisement, control circuitry 504 begins to monitor media guidance application data to determine which content source to access next. Control circuitry 504 searches through content source information for each of the other N content sources sequentially for a media asset that matches the genre of the first media asset. For example, if content source 522 is the first content source, then once control circuitry 504 detects that content source 522 contains an advertisement at 5 PM, control circuitry 504 searches the content source information for the subsequent content source, content source 523. Control circuitry 504 determines if content source 523 includes a media asset at 5 PM that matches the genre associated with the media asset being displayed on display unit 506 at 5 PM from content source 522.

In other embodiments, control circuitry 504 may continuously monitor content source information for all N content sources in parallel to determine which media assets match the genre of the first media asset. Such a continuous monitoring process involves tracking media asset metadata. For example, control circuitry 504 may monitor the fields which contain genre information in the data feeds for all N content sources. By continuously monitoring the content source information of all N content sources in real time, control circuitry 504 will have a greater awareness of which content source contains a media asset with a genre matching the first media asset at any given time than by just monitoring one content source information at a time, sequentially. When control circuitry 504 receives the request to change the displayed media asset, control circuitry 504 already has such genre based media asset availability information for all N content sources. This allows for a faster channel switching process since control circuitry 504 no longer has to determine which content source contains a media asset with the desired genre by examining each content source's content source information one at a time after receiving the request to change the displayed media asset.

Once control circuitry 504 identifies a content source that contains a media asset with a genre matching the first media asset at 5 PM, control circuitry 504 processes the content source information of the identified content source. The content source information of the identified media asset is processed to identify data that is indicative of an advertisement being provided at the content source at 5 PM. In some embodiments, if control circuitry 504 determines that the identified content source does not contain an advertisement as result of processing its content source information, then the identified media asset is received at the user equipment device. If control circuitry 504 determines that the identified content source contains an advertisement, the content source information for the next content source that includes a media asset with a genre matching the first media asset is checked for advertisements at 5 PM. Control circuitry 504 steps through each of the identified content sources until a content source that provides a media asset without an advertisement is identified.

In an embodiment, control circuitry 504 receives a user request to access another media asset than the currently displayed media asset on display 506. Accordingly, control circuitry 504 may continuously poll user input interface 508 for user input to access another media asset. In another implementation, control circuitry 504 may poll user input interface 508 for user input to access another media asset at periodic time intervals.

Once control circuitry 504 receives a user request to view a different media asset than the media asset currently being accessed, control circuitry 504 begins to search for other media assets that match the genre of the first media asset in content sources 522-525, as described in the embodiments above. Once such content sources are identified, control circuitry 504 further determines which of the identified content sources do not contain an advertisement at 5 PM, as described in the embodiments above. After control circuitry 504 has identified the suitable content sources, control circuitry 504 may retrieve the media assets transmitted on the identified content sources at 5 PM and display these media assets on display unit 506.

According to several embodiments, once a suitable content source is identified, control circuitry 504 retrieves the media asset transmitted on the identified content source at 5 PM. In an embodiment, the retrieved media asset may be stored in storage unit 502 and then displayed in display unit 506. In another embodiment, the retrieved media asset may be directly displayed at display unit 506.

In some embodiments, once a suitable media asset is identified, control circuitry 504 continues searching for another suitable content source that contains a different media asset with a genre matching the first media asset and that does not contain an advertisement at 5 PM from the one identified. This search is performed even though one suitable media asset has been identified in order to provide the user with a list of multiple media assets to choose from.

Once control circuitry 504 finishes identifying all suitable content sources that contain a media asset matching the genre of the first media asset and do not provide an advertisement at 5 PM, control circuitry 504 retrieves media assets transmitted at 5 PM from all of the identified content sources. Control circuitry 504 may determine whether the identified media assets are locally stored at storage 502 or are stored at remote content sources. Control circuitry may search storage 502 for the identified media assets to make such a determination. In response to determining that the identified media assets are stored at storage 502, control circuitry 502 may retrieve these media assets from storage 502 for display at display 506. On the other hand, if control circuitry 504 determines that the identified media assets are stored at remote content sources, control circuitry 504 may send a request to the identified content sources of the identified media assets to transmit the identified media assets to storage 502.

In another embodiment, once control circuitry 504 identifies the first suitable content source, control circuitry 504 retrieves the media asset transmitted at 5 PM on the first suitable content source while simultaneously searching for a second suitable content source. For example, control circuitry 504 simultaneously searches through media guidance application data for media assets that match the genre of the first media asset and retrieves media assets from content sources that have been identified to contain matching genre media assets without advertisements at the given time of the request. In a similar fashion, as more suitable content sources are identified, media assets are retrieved while control circuitry 504 searches for additional suitable content sources.

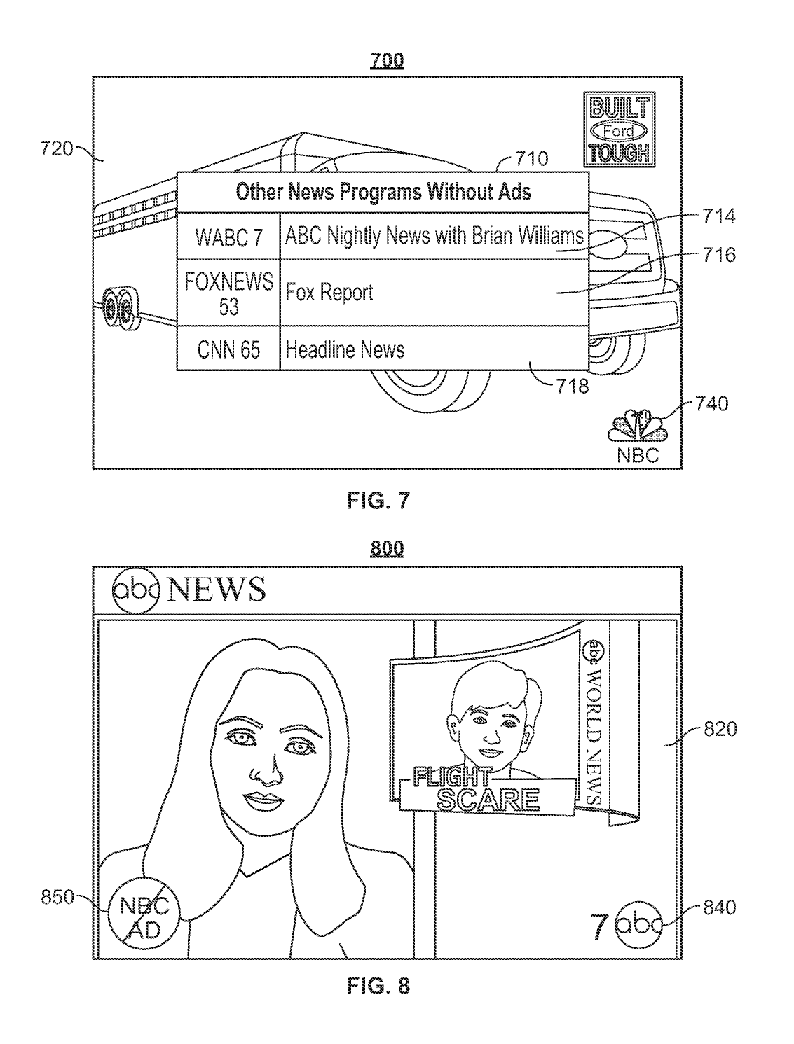

In some of the embodiments described above, control circuitry 504 may be configured to display media listings of multiple media assets that match the genre of the first media asset and which are part of content sources that do not include advertisements at 5 PM. Control circuitry 504 may search content source information for all N content sources stored in the media guidance application data. Control circuitry 504 may then search the content source information of all N sources for media assets displayed at 5 PM that match the genre of the first media asset. Once control circuitry 504 has identified the content sources that are associated with the matching genre media assets, control circuitry 504 may then further determine if these identified content sources contain advertisements at 5 PM by processing their associated content source information for information indicative of an advertisement being provided on the content source at 5 PM. Control circuitry 504 continues checking the content source information for different content sources until all of the suitable content sources from the available N content sources have been identified. After all the suitable content sources and their respective media assets that are transmitted at 5 PM have been identified, control circuitry 504 displays media listings of all of the identified media assets on display unit 506, as shown in FIG. 7 (discussed below). The user may select the desired media listing using user input interface 508. Once control circuitry 504 receives the user selection of a media listing from user input interface 508, control circuitry 504 accesses the content source corresponding to the selected media asset listing and the selected media asset is displayed on display unit 506.

In an embodiment, after control circuitry 504 has switched the media asset displayed at display 506 to a second media asset, control circuitry 504 continuously monitors the first content source of the first media asset to determine if the first content source still includes an advertisement. Control circuitry 504 searches through the data feed of the first content source for information indicative of an advertisement. As soon as control circuitry 504 determines that the first content source no longer displays an advertisement, control circuitry 504 checks whether the genre of the media asset displayed on the first content source still matches the genre of the first media asset as described in the embodiments above. If control circuitry 504 determines that the genre of the first control source's media asset is a match with that of the first media asset, then control circuitry 504 displays a prompt on display 506 to access the first content source. In another embodiment, control circuitry 504 displays a visual indicator on display unit 506 instead of displaying a prompt to access the first content source. Such a visual indicator may be any combination of graphics and words. For instance, the visual indicator may just be the words “No Ad In Last Channel” displayed on the display screen or it might be a check mark to indicate that the advertisement in the last channel is no longer present.

In another embodiment, control circuitry 504 determines that the second media asset is scheduled to end at a given time, 7 PM for example. Control circuitry 504 may search the media guidance application data for the second media asset to find information that indicates the end time of the second media asset. In response to such a determination, control circuitry 504 determines if the next media asset transmitted on the second content source at 7 PM matches the genre associated with the genre of the first media asset. For example, control circuitry 504 searches the content source information in the media guidance application database to identify the media asset that airs on the second content source immediately after the second media asset, hereinafter referred to as the next media asset on the second content source. Control circuitry 504 searches the genre fields of the data structures associated with the next media asset for the second content source in the media guidance application database to determine the genre of the next media asset on the second content source. If control circuitry 504 determines that the next media asset on the second content source does not match the genre of the first media asset, then control circuitry 504 searches for another media asset that matches the first media asset's genre and that does not contain an advertisement at 7 PM in accordance with the previous embodiments.

In another embodiment, control circuitry 504 may be configured to switch to a content source that the user has designated as a favorite content source. The user may be presented with an option to designate a content source as a favorite content source at any time. For instance, a user may designate a content source as a favorite content source by pressing a button label “Favorite” on user input interface 508. Control circuitry 504 may be configured to detect that the “Favorite” button was actuated. Once control circuitry 504 determines that the “Favorite” button has been actuated, control circuitry 504 may present the user with an option to designate the content source of the currently displayed media asset as a favorite content source. In another implementation, a user may designate a content source as a favorite content source by selecting an option in the media guidance application that allows the user to designate a content source as a favorite content source. Control circuitry 504 may be further configured to add the designated favorite content source to a list of designated favorite content sources.

In an embodiment, control circuitry 504 may be configured to provide a user selectable option to skip advertisements. Such an option may be displayed in the media guidance application. In another implementation, the user may press a skip ad button on user input interface 508 to activate the option to skip advertisements. Once control circuitry 504 determines that the option to skip advertisements has been selected, control circuitry 504 may begin monitoring content source information of the first content source to detect whether the first content source includes an advertisement. Once control circuitry 504 determines that the first content source includes an advertisement, control circuitry 504 may begin the process of identifying which media asset to next display on display 506.

In an embodiment, control circuitry 504 may be configured to access a designated favorite content source once control circuitry 504 determines that the first content source includes an advertisement. In another implementation, control circuitry 504 may switch the displayed media asset on display 506 from the first media asset to a media asset from a designated favorite content source once control circuitry 504 determines that the first content source includes an advertisement and that the user has selected the option to skip advertisements. For example, control circuitry 504 may determine that the user has selected the option to skip advertisements in the media guidance application. In response to making such a determination, control circuitry 504 may monitor the first content source information to determine when an advertisement is included in the content source. Once control circuitry 504 determines that the first content source currently includes an advertisement, control circuitry 504 may determine whether a designated first favorite content source currently includes an advertisement. If control circuitry 504 determines that the designated first favorite content source content source does not currently include an advertisement, control circuitry 504 accesses the designated first favorite content source and may display the media asset provided by the designated first favorite content source on display 506. However, if control circuitry 504 determines that the first favorite content source includes an advertisement, then control circuitry 504 determines whether a designated second favorite content source currently includes an advertisement. If control circuitry 504 determines that the second favorite content source does not currently include an advertisement, then control circuitry 504 accesses the second favorite content source and may display the media asset provided by the second favorite content source on display 506. Control circuitry 504 may be further configured to continue the process of checking each designated favorite content source until it finds a designated favorite content source that does not currently include an advertisement.

In several embodiments described above, once control circuitry 504 has accessed a designated favorite content source, control circuitry 504 continues monitoring the first content source information to determine if the first content source still includes an advertisement. As soon as control circuitry 504 determines that the first content source no longer includes an advertisement, control circuitry 504 may access the first content source and may display the first media asset on display 506. In an implementation, control circuitry 504 may display a visual indicator on display 506 when it determines that the first content source no longer includes an advertisement. Such a display indicator may signal the user that the first media content no longer includes an advertisement. In another implementation, control circuitry 504 may display a message on display 506 indicating that the first content source no longer includes an advertisement.

In some embodiments, a user may be alerted that a first content source no longer includes an advertisement while a user is performing another activity on user equipment device 300 besides watching a media asset. For example, control circuitry 504 may detect that the user is browsing through a media listing grid such as grid 102 when it determines that the first content source no longer includes an advertisement. Control circuitry 504 may detect that the user is browsing such a media listing grid by detecting that the media listing grid is displayed on display 506. In response to determining that the first content source no longer includes an advertisement while media listing grid 102 is displayed on display 506, control circuitry 504 may display a visual indicator on display 506 to alert the viewer that the first content source no longer includes an advertisement. Such a visual indicator may be selected to display the currently displayed media asset from the first content source. In another implementation, control circuitry 504 may display a message on display 506 to indicate the first content source no longer includes an advertisement. In an implementation, control circuitry 504 may provide the user to select an option in the displayed message to display the currently displayed media asset from the first content source on display 506. In these implementations, the message or visual indicator may be overlaid on top of the currently displayed content on display 506.

In another embodiment, control circuitry 504 may be configured to display a message on display 506 indicating that the first content source no longer includes an advertisement while the user is browsing through different content sources. Users may start browsing through different content sources once an advertisement displays in the content source that they were watching. However, once the advertisement in the first content source ends, the user may desire to be notified whilst browsing through different content sources that the first content source no longer includes an advertisement. Accordingly, control circuitry 504 may be configured to detect that different content sources are being browsed through. Control circuitry 504 may detect that the user is browsing through different content sources by either detecting that the user has activated an automatic content source browsing function in the media guidance application function. Alternatively, control circuitry 504 may detect that the user is browsing through different content sources by detecting that the a content source is accessed for a time period less than a predetermined amount of time before accessing a different content source. In response to determining that the user is browsing through different content sources, control circuitry 504 displays a message indicating that the first content source no longer includes an advertisement. In an implementation, control circuitry 504 may provide the user to select an option in the displayed message to display the currently displayed media asset from the first content source on display 506. In another implementation, control circuitry may display a visual indicator on display 506 to indicate that the first content source no longer includes an advertisement. Such a visual indicator may be selected to display the currently displayed media asset from the first content source. The visual indicator may be an icon consisting of any combination of graphics and text. Alternatively, the visual indicator may be a pop-up window overlaid over the video displayed on display 506.

In another embodiment, control circuitry 504 may be configured to automatically display the first media asset in response to determining that the first content source no longer includes an advertisement and that the user is performing another activity on user equipment device 300 besides watching a media asset. For example control circuitry 504 may detect that the user is viewing media listings grid 102 on display 506. When control circuitry 504 detects that the first content source no longer includes an advertisement, control circuitry 504 may automatically display the first media asset. In a particular implementation, control circuitry 504 may simultaneously display media listing grid 102 along with the first media asset in a picture in picture mode. Alternatively, control circuitry may overlay grid 102 over the first media asset while increasing the transparency of grid 102 such that the first media asset may be viewed underneath the overlaid semi-transparent grid 102. In another implementation, control circuitry 504 may not display media listing grid 102 after automatically displaying the first media asset on display 506.

In another implementation, control circuitry 504 may be configured to automatically display the first media asset on display 506 when it determines that the first content source no longer includes an advertisement and that the user is currently browsing through different content sources. In response to determining that the user is currently browsing through different content sources, control circuitry 504 may be configured to further determine whether the first content still includes an advertisement. Once control circuitry 504 determines that the first content source no longer includes an advertisement, control circuitry 504 automatically display the first media asset on display 504. Control circuitry 504 may also exit any pre-selected content source browsing function in response to determining that the first content source no longer includes an advertisement.

In some embodiments, control circuitry 504 pauses playback of the first media asset when it determines that the first media asset is not displayed and that the first content source no longer includes an advertisement. The user may be performing a media guidance application function that the user may desire to finish before returning to watching the first media asset. Alternatively, the user may be watching a media asset on a different content source that the user may desire to finish watching. Accordingly, control circuitry 504 may determine that the first media asset is not being displayed on display 506. In response to such a determination, control circuitry 504 may continue monitoring the first content source information to determine whether the first content source no longer includes an advertisement. Once control circuitry 504 determines that the first content source no longer includes an advertisement, control circuitry 504 pauses playback of the first media asset. In an implementation, control circuitry 504 may record the first media asset on storage 502 from the moment the first content source stopped including the advertisement. Once control circuitry 504 determines that the user has finished the other media guidance application function or has finished watching the other media asset, control circuitry 504 may be configured to automatically display the first media asset on display 506 resuming playback from the moment that the first media asset was paused from. For example, control circuitry 504 may resume playing back the recorded first media asset from the time that the first media content stopped including the advertisement.

FIG. 6 shows an illustrative display screen 600 displaying a first media asset displayed on display 506 as discussed in some of the embodiments above. Portion 620 of display screen 600 shows the first media asset, NBC Nightly News with Brian Williams, retrieved from a first content source, NBC. Indicator 640 displays the logo of the content source provider. Portion 620 may be a full screen display of the first media asset. In another implementation, portion 620 may only occupy a specific sub-portion of screen 600. Additional content, related or unrelated to the first media asset, may be displayed on the portion of screen 600 not occupied by the first media asset 620.

In this example, control circuitry 504 detects the genre associated with the NBC Nightly News media asset. Control circuitry 504 searches media guide application data stored in storage 502 for information related to NBC Nightly News. Once the content source information for NBC Nightly News is found, control circuitry 504 searches fields of the data structure for this media asset. By examining the field associated with the genre in a data structure for NBC Nightly News, control circuitry 504 determines that NBC Nightly News's genre is news.

In some embodiments, control circuitry 504 continuously searches the content source information of the NBC content source to determine whether the NBC content source includes an advertisement. Control circuitry 504 monitors a data feed for the NBC content source. Control circuitry 504 searches the data for information including text and closed captioning information that indicates whether the NBC content source includes an advertisement. Once control circuitry 504 detects an advertisement in the NBC content source, control circuitry 504 begins searching for another media asset from a different content source which matches the genre of the first media asset and which is received from a content source that does not contain an advertisement at 5 PM.

Accordingly, control circuitry 504 searches a media guidance application database to identify a content source that contains a media asset with a genre matching the news genre of the NBC Nightly News media asset. Control circuitry 504 searches through a media guidance database, which may be stored in storage 512 or at any other appropriate location, to identify another media asset that is available at 5 PM and also is classified with the news genre. In the example depicted in FIG. 6, control circuitry 504 determines that a second media asset “ABC Nightly News” is available on another content source, ABC, at 5 PM and that it also matches the news genre of NBC Nightly News. In response to identifying this second media asset, control circuitry 504 then determines whether the second content source, ABC, contains an advertisement at 5 PM. Control circuitry 504 searches the data feed associated with the ABC content source for information indicative of an advertisement. For example, control circuitry 504 searches closed captioning information for text or other information indicating the presence of an advertisement to determine if the ABC content source contains an advertisement. If control circuitry 504 determines that the ABC content source contains an advertisement, then the data feed for another content source is searched from the media guidance application database for another media asset until a suitable media asset is found. If control circuitry 504 determines that the ABC content source does not provide an advertisement at 5 PM, then control circuitry 504 displays a message 630 on display screen 600 that notifies the user that an advertisement has been detected in the currently displayed media asset's content source and that a second media asset is available for display and does not have an advertisement being displayed—ABC Nightly News in this example. Control circuitry 504 may display message 630 as an overlay superimposed on top of the video of the displayed first media asset 620. In some embodiments, control circuitry 504 automatically accesses the second media asset after displaying message 630 without any further user input. For instance, once control circuitry 504 displays message 630, control circuitry might display the message for a predetermined amount of time (i.e., 5 seconds). After these 5 seconds have lapsed, control circuitry 504 retrieves the video of the second media asset from the second content source and displays it on display 506.

In some embodiments, control circuitry 504 waits for a user request to change the displayed media asset. This allows the user the ability to actively change media assets instead of only allowing the system to change the displayed media asset in response to an advertisement being displayed on the first content source. Control circuitry 504 continuously polls user input interface 508 for a user request to change the displayed media asset. Once control circuitry 504 determines that it has received the user request to change the media asset, control circuitry 504 begins searching for a suitable second media asset from a second source.

In response to receiving the user request to change the displayed media asset, control circuitry 504 searches a media guidance application database to identify a content source that contains a media asset with a genre matching the news genre of the NBC Nightly News media asset. Control circuitry 504 searches through the media guidance application database, which may be stored in storage 512 or at any other appropriate location, to identify another media asset that is available at 5 PM and also is classified with the news genre. In the example depicted in FIG. 6, control circuitry 504 determines that a second media asset “ABC Nightly News” is available on another content source, ABC, at 5 PM and that it also matches the news genre of NBC Nightly News. In response to identifying this second media asset, control circuitry 504 then determines that second content source, ABC, contains an advertisement at 5 PM. Control circuitry 504 searches the data feed associated with the ABC content source for information indicative of an advertisement. For example, control circuitry 504 searches closed captioning information for text or other information indicating the presence of an advertisement to determine if the ABC content source contains an advertisement. If control circuitry 504 determines that the ABC content source contains an advertisement, then the data feed for another content source is searched from the media guidance application database for another media asset until a suitable media asset is found. If control circuitry 504 determines that the ABC content source does not provide an advertisement at 5 PM, then the user is allowed to select ABC Nightly News for display on display screen 630. Control circuitry 504 may display a prompt querying the user to display text indicating that ABC Nightly News is the media asset that was found. The prompt may also further indicate that ABC Nightly News was found to have the same genre as the currently displayed media asset and that the ABC content source does not provide an advertisement. In another implementation, control circuitry 504 may search for other media assets that match the news genre and which are also provided on content sources that do not include an advertisement at 5 PM. Control circuitry 504 may then allow the user to select between ABC Nightly News and these other media assets as shown in FIG. 7.

In some embodiments, control circuitry 504 may constantly monitor the NBC content source information to determine whether the NBC content source includes an advertisement. As soon as control circuitry 504 determines that an advertisement is included in the NBC content source, control circuitry 504 determines whether a designated first favorite content source currently includes an advertisement. Once control circuitry 504 determines that the first favorite content source does not currently include an advertisement, control circuitry 504 accessed the first favorite content source and displays the media asset displayed on the first favorite content source. If control circuitry 504 determines that the first favorite content source currently includes an advertisement, then control circuitry 504 determines whether a designated second favorite content source currently includes an advertisement. In such a manner, control circuitry 504 may be configured to search through a list of previously designated favorite content sources to determine which favorite content source does not currently include an advertisement. Once control circuitry 504 determines the favorite content source that does not currently include an advertisement, control circuitry 504 accesses that favorite content source and displays the media asset currently presented on that favorite content source on screen 600.

FIG. 7 shows an illustrative display screen 700 that displays several listings to the user for media assets that have been found to match the genre of the first media asset, NBC Nightly News, and that are provided on content sources that do not contain advertisements at 5 PM. Display screen 700 is displayed after an advertisement has been detected in the first media asset or the user has requested to change the displayed media asset as discussed above with relation to FIG. 6.

In the embodiment shown in FIG. 7, the user is presented with several media listings of media assets that belong to the same news genre as the first media asset and do not currently contain advertisements in their respective channels.

List 710 of media asset listings is generated by control circuitry 504 after determining which content sources of content sources 522-525 contain media assets at the current time that match the news genre of the first media asset. Control circuitry 504 then determines which of the identified content sources currently do not include an advertisement by processing the content source information of the identified content sources. Finally, control circuitry 504 displays the list of media assets that meet both of the above mentioned criteria. These media assets are displayed in list 710. In the example shown in FIG. 7, media listing 714, 716, and 718 are listings of the media assets that are news programs and are transmitted on content sources that do not include an advertisement. Media listings in list 710 may be arranged according to a predetermined order such as an increasing channel number.

In some embodiments, after determining that the first content source, NBC channel 4, contains an advertisement, control circuitry 504 displays a list of media listings for other news programs without advertisements. List 710 of media listings may be identical to the media listings shown in FIG. 1 which have been filtered to only display the media listings that match the genre of the first media asset and which are provided on content sources that do not include advertisements.

Portion 720 may display the advertisement in the NBC channel that the user may wish to skip. List 710 may be superimposed on top of the displayed advertisement. In this implementation, the user may not have had enough time to select a media listing before the first content source started displaying the Ford advertisement shown in portion 720. In another implementation, list 710 may be displayed on top of a first media asset if the list is displayed before the first content source provides the Ford advertisement.

A user may scroll through list 710 using user input interface 508. As the user scrolls through each media listing in list 710, the user may be further presented with additional information related to the media assets associated with the media listings. Using user input interface 508, the user may select a particular media listing. As shown in FIG. 7, the media listing 714 has been selected. Control circuitry 504 receives such a selection of the media listing and accordingly accesses the WABC 7 channel.

Once control circuitry 504 has determined which content source the user has selected to access, control circuitry 504 displays a video of the selected second media asset on display unit 506.

Accordingly, FIG. 8 shows a second media asset being displayed on display screen 800. The second media asset is ABC Nightly News on ABC channel 7. Indicator 840 displays the logo of the content source provider. Portion 820 may be a full screen display of the second media asset video. In another implementation, portion 820 may only occupy a specific sub-portion of screen 800. Additional content, related or unrelated to the first media asset, may be displayed on the portion of screen 600 not occupied by the first media asset 620.

Upon displaying the second media asset video 820 on display 506, control circuitry 504 determines whether the first content source, NBC, is no longer displaying an advertisement. For example, control circuitry 504 monitors the first content source's data feed to determine whether the first content source still provides an advertisement after the displayed media asset has been switched to ABC Nightly News. Upon determining that the first media content no longer displays an advertisement, control circuitry 504 further determines whether the first content source is still displaying the first media content. For instance, control circuitry 504 searches data structures in the media guidance application database for the first content source to determine whether the first media asset has not ended at the time when control circuitry 504 determines that the first content source does not include an advertisement. When control circuitry 504 detects that the first content source, NBC, is no longer displaying an advertisement and is still displaying the first media asset, a visual indicator 850 may be displayed. Visual indicator 850 may be any combination of graphics and text. In FIG. 8, indicator 850 indicates that an advertisement on the NBC channel is no longer being displayed. Indicator 850 may be selected by the user using user input interface 508. Control circuitry 508 continuously polls whether user input interface has received a user selection of indicator 850. Once control circuitry 504 determines that the user has selected visual indicator 850, control circuitry 504 displays the video of the first media asset on portion 820. For example in the embodiment shown in FIG. 8, once control circuitry 504 determines that the visual indicator 850 has been selected by user input interface 508, control circuitry 504 accesses the first media asset, NBC Nightly News with Brian Williams.

In some embodiments, control circuitry 504 may determine whether the ABC content source contains an advertisement. In response to determining that the ABC content source includes an advertisement, control circuitry 504 may be configured to display a list of media listings for other programs of the same genre as ABC Nightly News, namely news programs, without advertisements similar to list 710. Such a list may be superimposed on top of the displayed video 820 in the ABC content source. Control circuitry 504 may be configured to display the first media asset, NBC Nightly News asset media listing in this example, as the first entry in the list. Control circuitry 504 may be configured to display a timing indication for the first media asset listing to indicate the period of time that has lapsed since the display 820 was switched from the first media asset to the second media asset. The timing indication may be a timer displayed on the first media asset listing. In another implementation, the timing indication may overlaid on top of the list of selectable media asset listings.

A user may scroll through such a list using user input interface 508. As the user scrolls through each media listing, the user may be further presented with additional information related to the media assets associated with the media listings. Using user input interface 508, the user may select a particular media listing. Upon receiving selection of a media listing, control circuitry 504 may access the channel of the selected media listing. Once control circuitry 504 has determined which content source the user has selected to access, control circuitry 504 displays a video of the selected media asset on display unit 506.

In an embodiment, once control circuitry 504 determines that the NBC content source no longer includes an advertisement, control circuitry 504 pauses the playback of the NBC Nightly news media asset. In an implementation, control circuitry 504 may record the NBC Nightly news media asset to storage 502 as soon as control circuitry 504 detects that the NBC content source no longer includes an advertisement. Such a recording of the NBC Nightly news media asset prevents the user from missing any portion of the advertisement free content from the NBC channel while the user is still watching the ABC Nightly News media asset. Once the user selects visual indicator 850, control circuitry 504 accesses storage 502 and displays the NBC Nightly News media asset from the moment that the NBC channel stopped including the advertisement. In an implementation, control circuitry 504 may continue recording the NBC Nightly News asset on storage 502 as it displays a previously recorded portion of the NBC Nightly News media asset on screen 800.

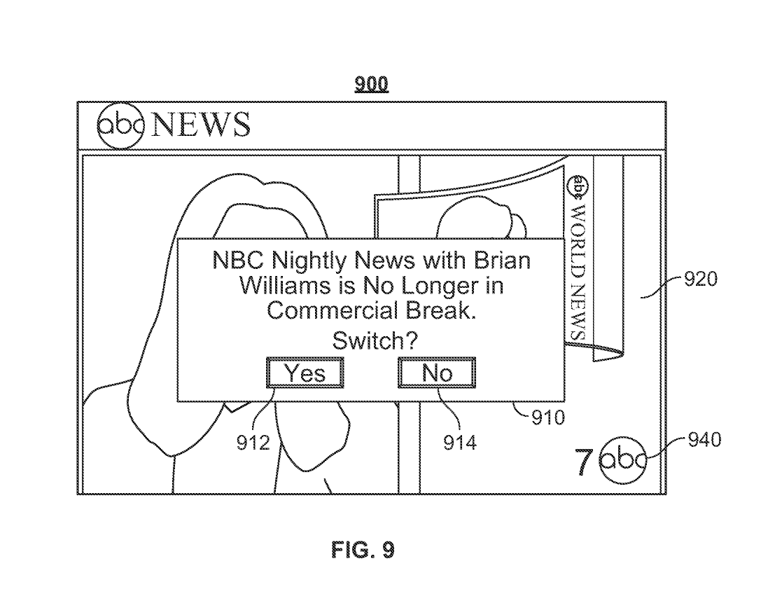

FIG. 9 shows an illustrative display screen 900 which is displayed in response to determining that the first content source, NBC, is no longer displaying an advertisement. Display screen 900 displays a prompt 910 which includes text asking the user to switch back to the first media asset when the first content source is no longer displaying an advertisement. Once control circuitry 504 determines that the first content source is no longer displaying an advertisement and still contains the first media asset, control circuitry 504 displays prompt 910 overlaid on top of the video of the second media asset displayed on portion 920. Prompt 910 indicates that the NBC channel no longer displays an advertisement. The prompt presents the option to access the first content source, a YES button 912 and the option to remain on the currently displayed media asset, NO button 914. If control circuitry 504 receives selection of the YES button 912 from user input interface 508, control circuitry 504 accesses the first content source NBC channel 4. However, if control circuitry 504 receives selection of the NO button, control circuitry 504 exits the prompt and resumes the unobstructed display of the second media asset.

In an embodiment, once control circuitry 504 determines that the NBC content source no longer includes an advertisement, control circuitry 504 pauses the playback of the NBC Nightly news media asset. In an implementation, control circuitry 504 may record the NBC Nightly news media asset to storage 502 as soon as control circuitry 504 detects that the NBC content source no longer includes an advertisement. Such a recording of the NBC Nightly news media asset prevents the user from missing any portion of the advertisement free content from the NBC channel while the user is still watching the ABC Nightly News media asset. Once the user selects YES button 912, control circuitry 504 accesses storage 502 and displays the NBC Nightly News media asset from the moment that the NBC channel stopped including the advertisement. In an implementation, control circuitry 504 may continue recording the NBC Nightly News asset on storage 502 as it displays a previously recorded portion of the NBC Nightly News media asset on screen 800. In another implementation, if control circuitry 504 detects that the user has selected NO button 914, control circuitry 514 may stop recording the NBC Nightly News media asset on storage 502. Control circuitry 504 may delete the recording of the NBC Nightly News media asset in storage 502 if it determines that the user has selected NO button 914.

In another embodiment, prompt 910 may include a third “Record” button which provides the user with the option of recording the first media asset while displaying the second media asset. For example, if control circuitry 504 detects that such a “Record” button has been selected by user input interface 508, control circuitry 504 may be configured to record the first media asset, NBC Nightly News, while displaying the second media asset, ABC Nightly News. Control circuitry 504 may also remove the display of prompt 910 once control circuitry 504 receives the user selection of such a third button.

In an embodiment, control circuitry 504 may be configured to display an additional prompt once control circuitry 504 detects that the third “Record” button has been selected by the user. Control circuitry 504 may be configured to present the user with the option record the portion of the first media asset that the user has not watched from the first content source or to search the media guide to find and record another occurrence of the first media asset in its entirety. If control circuitry 504 determines that the user has selected the option to record the portion of the first media asset that the user has not watched, control circuitry 504 may record the first media asset while displaying the second media asset on display screen 900. If control circuitry 504 determines that the user has selected the option to find and record another occurrence of the first media asset in its entirety, control circuitry 504 may search through the media guidance data source 418 to identify another occurrence of the first media asset. If control circuitry 504 finds another occurrence of the first media asset, control circuitry 504 may be configured to record that occurrence of the first media asset in its entirety.

In another embodiment, once control circuitry 504 determines that the NBC content source no longer includes an advertisement, control circuitry 504 automatically accesses the NBC content source and replaces screen 900's display of the ABC Nightly News with the NBC Nightly News media asset.

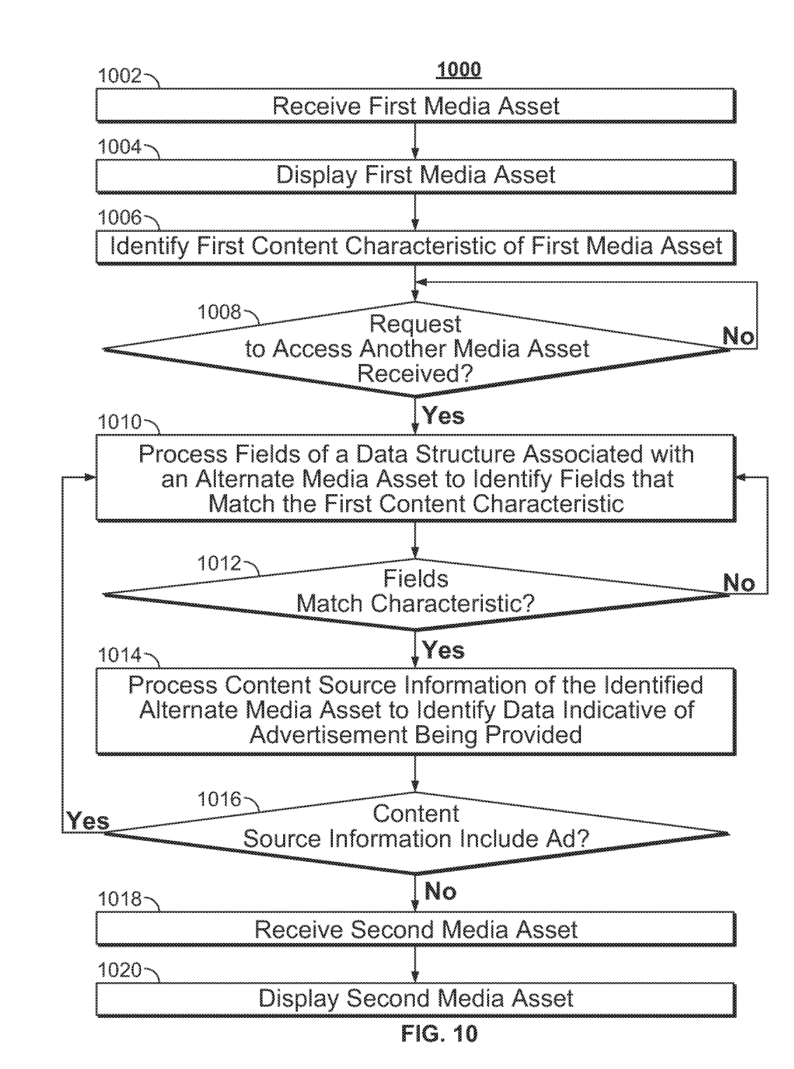

The following flow charts of FIGS. 10-13 serve to illustrate processes involved in some embodiments of the invention. Where appropriate, these processes may, for example, be implemented completely in the processing circuitry of a user equipment device (e.g., control circuitry 304 of FIG. 3) or may be implemented at least partially in a remote server. It should be understood that the steps of the flow charts are merely illustrative and any of the depicted steps may be modified, omitted, or rearranged, two or more of the steps may be combined, or any additional steps may be added, without departing from the scope of the invention. Also, some of the steps may be executed or performed substantially simultaneously where appropriate or in parallel to reduce latency and processing times.

At step 1002, the first media asset is received. For example, control circuitry 504 may receive the first media asset from the first content source.

At step 1004, the first media asset is displayed at display unit 506.

At step 1006, the first content characteristic of the first media asset is identified. For example, control circuitry 504 identifies the genre of the first media asset as news by searching the fields associated with genre information in the media guidance application data structures for the identified media asset.

At step 1008, a determination is made whether a request to access another media asset has been received. For example, control circuitry 504 checks continuously or at periodic intervals whether a request to change the media asset that is displayed has been received. Such a request may be initiated by the user using user input interface 508 or it may be initiated by control circuitry 504. For instance, control circuitry 504 may determine that an advertisement will be transmitted on the displayed first media asset's content source and accordingly, control circuitry 504 will initiate the request to access another media asset. Control circuitry 504 will continue accessing the first content source until such a request has been received.

At step 1010, in response to receiving such a request, control circuitry 504 processes the fields of a data structure associated with an alternate media asset to identify fields that match the first content characteristic. For example, control circuitry 504 retrieves the data feed which stores another content source's information. By processing the fields of such a data structure associated with the alternate content source, control circuitry 504 identifies whether this alternate media asset is associated with a matching content characteristic (genre in our example) of the first media asset.

At step 1012, control circuitry 504 determines if the fields of the data feed match the first media characteristic. If the fields do not contain information indicative of a match with a first content characteristic (the genre of the first media asset), then control circuitry 504 loops back to the step 1010 to process the data feed of another media asset of another content source.

At step 1014, in response to determining that the data structure fields match the first content characteristic, control circuitry 504 proceeds to process the content source information of the identified alternate media asset to identify data indicative of an advertisement being provided on the alternate media asset's content source. For example, control circuitry 504 examines the data feed of the alternate media asset to identify information regarding any advertisements present in its content source at the given time of the content source switch.

At step 1016, control circuitry 504 determines whether the content source information for the identified alternate media asset's content source contains information indicative of an advertisement present in its content source. If control circuitry 504 determines that the alternate content source does include an advertisement at the given time of the switch, then control circuitry 504 loops back to step 1010 to find another media asset from a different content source.

At step 1018, in response to determining that the alternate content source does not contain an advertisement at the given time of the switch, control circuitry 504 receives the second media asset (the alternate media asset) from the second content source.

At step 1020, control circuitry 504 displays the second media asset on display unit 506.

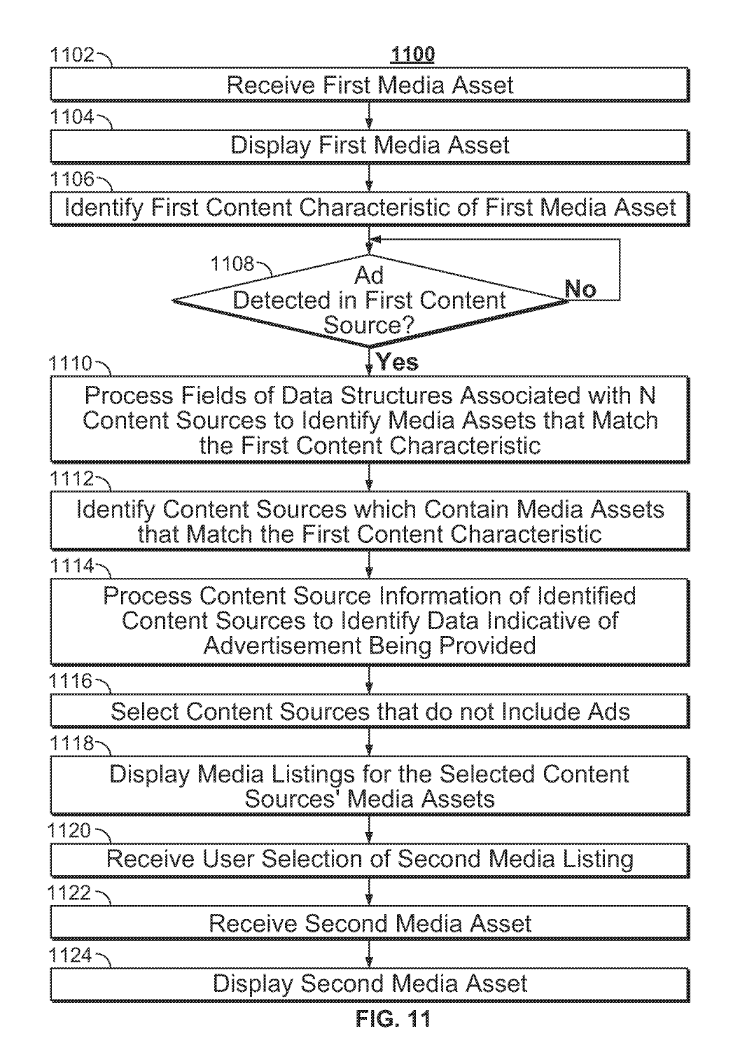

FIG. 11 illustrates a flow diagram containing processes in accordance with a different embodiment from the one depicted in FIG. 10.

At step 1102, the first media asset is received. For example, control circuitry 504 may receive the first media asset from the first content source.

At step 1104, the first media asset is displayed at display unit 506.

At step 1106, the first content characteristic of the first media asset is identified. For example, control circuitry 504 identifies the genre of the first media asset as news according to the example provided in the embodiments above.

At step 1108, control circuitry 504 determines whether an advertisement was detected in the first content source. For example, control circuitry 504 checks continuously or at periodic intervals whether an advertisement has been detected in the first content source by monitoring the data feed associated with the first content source.

At step 1110, when control circuitry 504 has detected that the first content source contains an advertisement, control circuitry 504 processes the fields of data structures (data feeds) of an N amount of content sources (content sources 522-525) to identify media assets that match the first content characteristic. For example, control circuitry 504 processes the data feeds of N content sources to identify media assets that match the news genre.

At step 1112, control circuitry 504 identifies the content sources from all N content sources that match the first content characteristic.

At step 1114, control circuitry 504 processes the content source information of the content sources identified in step 1112 to identify data indicative of an advertisement being provided in each of these identified content sources at the given time of the switch.

At step 1116, control circuitry 504 selects the content sources that do not include advertisements as a result of processing the content source information of each of these content sources in step 1114.

At step 1118, control circuitry 504 displays media listings of the media assets transmitted on each of the selected content sources at the given time of the switch. For example, control circuitry 504 displays a list as shown in FIG. 7 of media listings on display unit 506.

At step 1120, control circuitry receives user selection of a media listing (the second media asset listing) from the list of media listings displayed in step 1118. For example, control circuitry 504 receives the user input from user input interface 508 to select a media listing from the media listing list.

At step 1122, control circuitry 504 receives the second media asset from the second content source.

At step 1124, control circuitry 504 displays the second media asset on display unit 506.

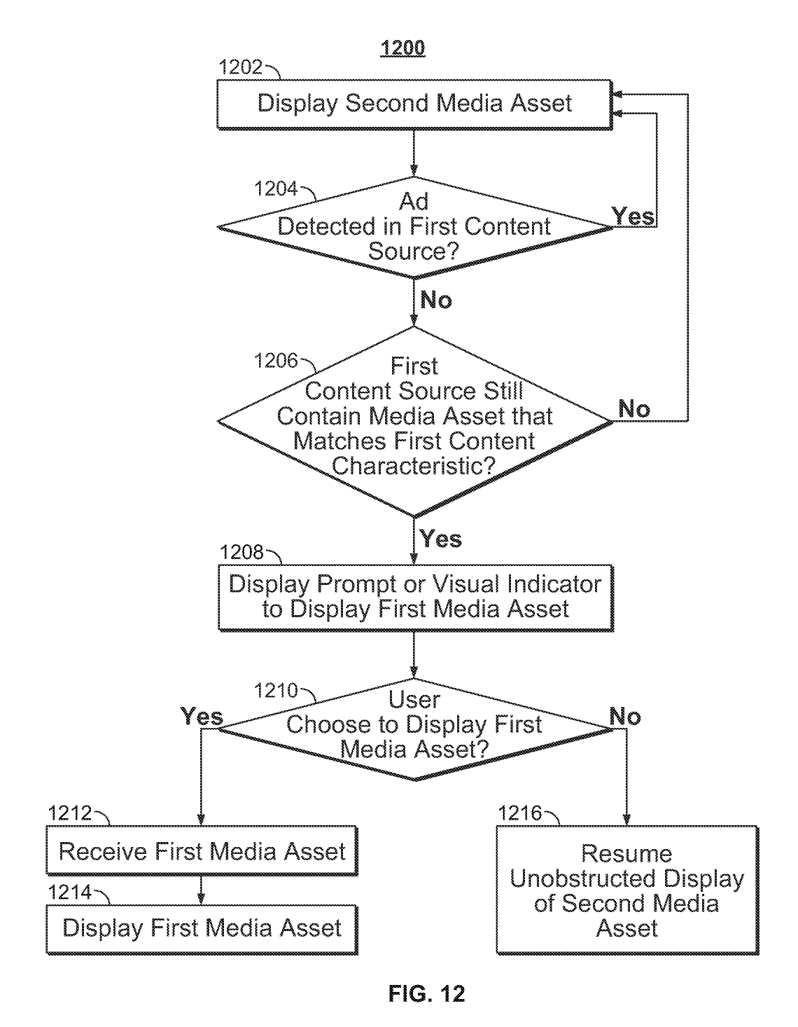

FIG. 12 illustrates a flow diagram containing processes that follow upon completion of the processes depicted in either FIG. 10 or FIG. 11.

At step 1202, control circuitry 504 displays the second media asset on display unit 506.

At step 1204, control circuitry 504 determines if an advertisement was detected in the first content source. For example, control circuitry 504 monitors the first content source's feed for information indicative of an advertisement present in the first content source since the moment the displayed media asset was switched. If an advertisement is still detected in the first content source, control circuitry 504 continues the unobstructed display of the second media asset.

At step 1206, as a result of determining that there was no advertisement detected in the first content source, control circuitry 504 further determines whether the first content source still contains a media asset that matches the first content characteristic. If control circuitry 504 detects that the first content no longer contains a media asset that matches the first content characteristic, then control circuitry 504 continues the unobstructed display of the second media asset.

At step 1208, as a result of determining that the first content source still contains media asset that matches the first content characteristic, control circuitry 504 displays a prompt or a visual indicator on display unit 506 to display the first media asset.

At step 1210, control circuitry 504 determines whether the user has chosen to display the first media asset. For example, control circuitry 504 receives user input from the user input interface 508 whether the user has chosen to display the first media asset.

At step 1216, as a result of determining that the user has not chosen to display the first media asset, control circuitry 504 resumes the unobstructed display of the second media asset on display unit 506.

At step 1212, as a result of determining that the user has chosen to display the first media asset, control circuitry 504 receives the first media asset from the first content source.

At step 1214, the first media asset is displayed on display unit 506.

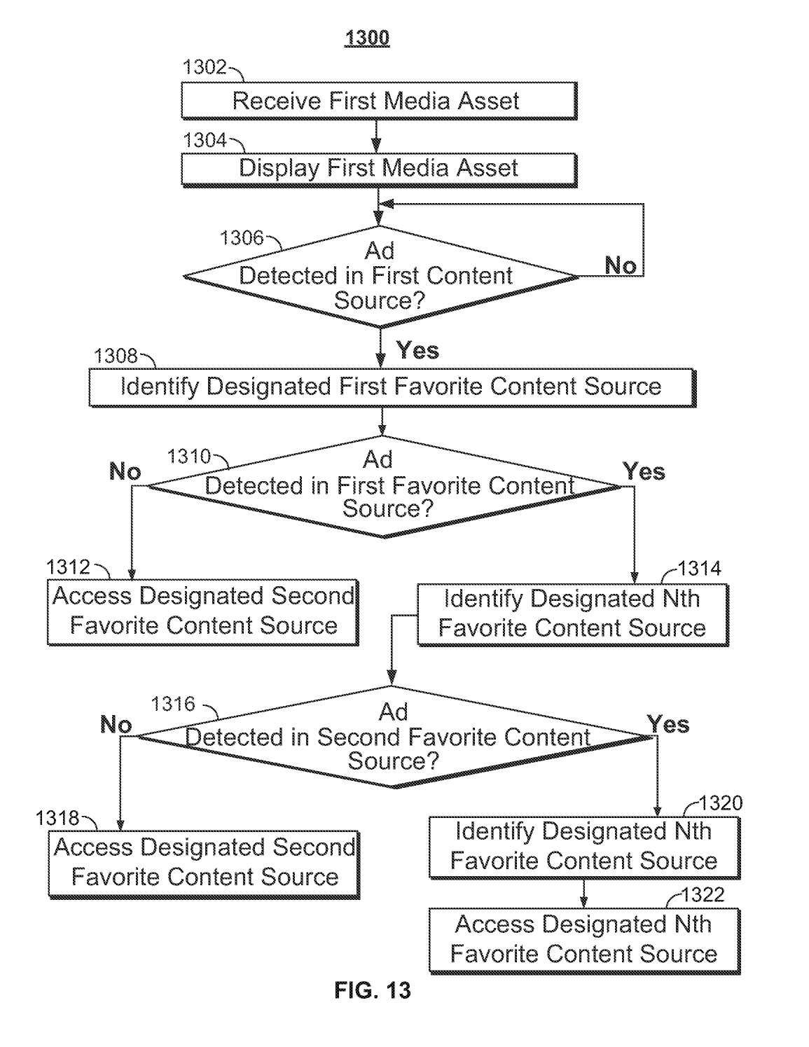

FIG. 13 illustrates a flow diagram containing processes in accordance with several embodiments related to accessing designated favorite content sources.

At step 1302, control circuitry 504 receives the first media asset from the first content source.

At step 1304, control circuitry 504 displays the first media asset on display 506.

At step 1306, control circuitry 504 determines whether the first content source includes an advertisement. For example, control circuitry 504 examines the first content source information to determine whether the first content source information includes any information indicative of an advertisement. Control circuitry 504 continuously monitors the first content source information until it determines that the first content source includes an advertisement.

At step 1308, control circuitry 504 identifies a designated first favorite content source in response to determining that the first content source includes an advertisement. Control circuitry 504 identifies the first favorite content source from a previously designated list of favorite content sources that the user may have created.

At step 1310, control circuitry 504 determines whether the first favorite content source currently includes an advertisement. For example, control circuitry 504 examines the first favorite content source information to determine whether the first favorite content source information includes any information indicative of an advertisement.

At step 1312, control circuitry 504 automatically accesses the designated first favorite content source in response to determining that the first favorite content source does not currently include an advertisement. Control circuitry 504 may also display the media asset currently received from the first favorite content source on display 506.

At step 1314, control circuitry 504 identifies a designated second favorite content source in response to determining that the first favorite content source currently includes an advertisement. Control circuitry 504 identifies the second favorite content source from a previously designated list of favorite content sources that the user may have created.

At step 1316, control circuitry 504 determines whether the second favorite content source currently includes an advertisement. For example, control circuitry 504 examines the second favorite content source information to determine whether the second favorite content source information includes any information indicative of an advertisement.

At step 1318, control circuitry 504 automatically accesses the designated second favorite content source in response to determining that the second favorite content source does not currently include an advertisement. Control circuitry 504 may also display the media asset currently received from the second favorite content source on display 506.

At step 1320, in response to determining that the second content source includes an advertisement, control circuitry 504 continues the process of identifying a designated favorite content source, determining whether a designated favorite content currently includes an advertisement until control circuitry 504 identifies that an Nth favorite content source does not currently include an advertisement.

At step 1322 control circuitry 504 automatically accesses the designated Nth favorite content source in response to determining that the Nth favorite content source does not currently include an advertisement. Control circuitry 504 may also display the media asset currently received from the Nth favorite content source on display 506.

It is to be understood that while certain forms of the present invention have been illustrated and described herein, it is not to be limited to the specific forms or arrangement of parts described and shown. Those skilled in the art will know or be able to ascertain using no more than routine experimentation, many equivalents to the embodiments and practices described herein. Accordingly, it will be understood that the invention is not to be limited to the embodiments disclosed herein, which are presented for purposes of illustration and not of limitation.

1. A method for displaying media assets on user equipment, the method comprising:
designating one of a plurality of content sources as a first favorite content source;
causing a first media asset received from a first content source to be displayed on the user equipment;
determining whether the first content source currently includes an advertisement; and
automatically accessing the first favorite content source in response to determining that the first content source currently includes an advertisement.

2. The method of claim 1, wherein the first favorite media content source is automatically accessed in response to determining that an option to skip advertisements has been selected at the user equipment.

3. The method of claim 1 further comprising determining whether the first content source no longer includes an advertisement.

4. The method of claim 3 further comprising displaying a message to indicate that the first content source no longer includes an advertisement in response to determining that the first content source no longer includes an advertisement.

5. The method of claim 3 further comprising displaying a visual indicator upon determining that the first content source no longer includes an advertisement.

6. The method of claim 3 further comprising displaying the first media asset upon determining that the first content source no longer includes an advertisement.

7. The method of claim 1, wherein determining whether the first content source includes an advertisement further comprises processing closed captioning information or information provided by the first content source to identify data indicative of an advertisement.

8. The method of claim 1, further comprising determining whether the designated first favorite content source includes an advertisement in response to determining that the first content source includes an advertisement.

9. The method of claim 8 further comprising:
in response to determining that the designated first favorite content source includes an advertisement, determining whether a second designated favorite content source includes an advertisement; and
automatically accessing the second favorite content source in response to determining that the second favorite content source does not include an advertisement.

10. The method of claim 1, further comprising:
determining whether the first content source no longer includes an advertisement;
determining whether the first media content is being displayed; and
pausing playback of the first media content in response to determining that the first media content is not being displayed and that the first content source no longer includes an advertisement.

11. A system for displaying media assets, the system comprising:
display screen, user input interface, and control circuitry coupled to the display screen and the user input interface, the control circuitry configured to:
designate one of a plurality of content sources as a first favorite content source;
cause a first media asset received from a first content source to be displayed on the display screen;
determine whether the first content source currently includes an advertisement; and
automatically access the first favorite content source in response to determining that the first content source currently includes an advertisement.

12. The system of claim 11, wherein the first favorite media content source is automatically accessed in response to determining that an option to skip advertisements has been selected.

13. The system of claim 11, wherein the control circuitry is further configured to determine whether the first content source no longer includes an advertisement.

14. The system of claim 13, wherein the control circuitry is further configured to display a message at the display screen to indicate that the first content source no longer includes an advertisement in response to determining that the first content source no longer includes an advertisement.

15. The system of claim 13, wherein the control circuitry is further configured to display a visual indicator at the display screen upon determining that the first content source no longer includes an advertisement.

16. The system of claim 13, wherein the control circuitry is further configured to display the first media asset at the display screen upon determining that the first content source no longer includes an advertisement.

17. The system of claim 11, wherein determining whether the first content source includes an advertisement further comprises processing closed captioning information or information provided by the first content source to identify data indicative of an advertisement.

18. The system of claim 11, wherein the control circuitry is further configured to determine whether the designated first favorite content source includes an advertisement in response to determining that the first content source includes an advertisement.

19. The system of claim 18, wherein the control circuitry is further configured to:
determine whether a second designated favorite content source includes an advertisement in response to determining that the designated first favorite content source includes an advertisement; and
automatically access the second favorite content source in response to determining that the second favorite content source does not include an advertisement.

20. The system of claim 11, wherein the control circuitry is further configured to:
determine whether the first content source no longer includes an advertisement;
determine whether the first media content is being displayed; and
pause playback of the first media content in response to determining that the first media content is not being displayed and that the first content source no longer includes an advertisement.

21-30. (canceled)
